(19) United States
(12) Patent Application Publication
(10) Pub. No.: US 2024/0391704 A1
(43) Pub. Date: Nov. 28, 2024

(54) ROBOT ASSISTED DIRECT TO GARMENT PRINTING

(71) Applicant: Electronics for Imaging, Inc., Londonderry, NH (US)

(72) Inventors: MARCO SERAFINI, Bergamo (IT); Ernesto Propersi Sterbiati, Carobbio degli Angeli (IT); Mattia Bonfanti Romanelli, San Pellegrino Terme (IT)

(21) Appl. No.: 18/670,465

(22) Filed: May 21, 2024

(30) Foreign Application Priority Data
May 23, 2023 (IT) 102023000010401

(51) Int. Cl. B65G 47/90

(52) U.S. Cl. CPC B65G 47/90; B65G 2201/0229

(57) ABSTRACT

Garments are placed on a self-propelled rack and shuttled to a robot which manages interaction of the garments with a printer. A self-propelled rack holds multiple garments, such as t-shirts. A robot removes a garment from the rack and loads the garment into a printer. After printing, the robot removes the garment from the printer and returns the printed garment to the rack. The robot comprises a robotic system that includes an arm having a curved member similar in shape to a bicycle handlebar or an ibex horn. The rack moves the printed garments through a dryer to effect drying of the garments.

### CROSS-REFERENCE TO RELATED APPLICATION

This application claims priority to Italian Patent Application No. 102023000010401 filed on May 23, 2023, which is incorporated herein by reference in its entirety.

### TECHNICAL FIELD

Various of the disclosed embodiments concern robot assisted direct to garment printing.

### BACKGROUND

Personalization of garments and accessories through direct-to-garment (DTG) printing is becoming more popular. Personalization of garments is currently a labor-intensive process that requires large areas for the machines to be placed so that skilled operators can work around the machines to handle the garments and operate the machines mostly in a piecemeal fashion. Large scale DTG printing operations can include multiple processing stages, such as loading, pretreatment, drying, and quality control all of which are labor intensive.

### SUMMARY

State of the art direct to DTG systems manage the garment, e.g. a t-shirt, garment-by-garment, with human operators moving the garments from station to station along the printing workflow. In embodiments of the invention garments are placed on a self-propelled rack and shuttled to a robot which manages interaction of the garments with a printer. This approach increases the speed of the garment printing process by significantly reducing the human effort required DTG printing.

Embodiments of the invention provide a self-propelled rack that holds multiple garments, such as t-shirts. A robot removes a garment from the rack and loads the garment into a printer. After printing, the robot removes the garment from the printer and returns the printed garment to the rack. In embodiments of the invention, the robot comprises a robotic system that includes an arm having a curved member similar in shape to a bicycle handlebar or an ibex horn.

In other embodiments of the invention, the rack moves the printed garments through a dryer to effect drying of the garments.

### BRIEF DESCRIPTION OF THE DRAWINGS

FIG. 1 is a plan schematic view of a garment rack showing a garment in place on the rack according to the invention;

FIG. 2 is a side elevation schematic view of a garment rack according to the invention;

FIG. 3 is a side elevation schematic view of a robot having a direct to garment ibex's-horn-shaped arm mounted thereto to move garment from a garment rack to a printer according to the invention;

FIG. 4 is a side elevation schematic view of the of FIG. 3 robot after moving the garment from the garment rack for transfer to the printer according to the invention;

FIG. 5 is a plan schematic view of a robot after moving the garment from the garment rack for transfer to the printer according to the invention;

FIGS. 6A-6E are plan schematic views of a robot picking up the garment from the garment rack for transfer to the printer according to the invention;

FIGS. 7A-7D are side elevation schematic views of a robot loading a garment onto a printer pallet, i.e. the printing support usually used in DTG printers (both traditional and digital printers) to lay the garment flat before pre-treatment and printing. The Robot slides the garment onto the pallet (FIG. 7A); the robot extends its arms away from the pallet (FIG. 7B); the robot's arms rise above the pallet (FIG. 7C) and retract back to the default position (FIG. 7D).

FIGS. 8A-8C are side elevation schematic views of a garment rack and robot according to the invention showing the garment rack bringing a load of garments to the robot (FIG. 8A); the garment rack engaged with the robot where the robot picks up a garment from the garment rack for printing (FIG. 8B); and the garment rack withdrawing from the robot after the robot has picked up a garment for printing (FIG. 8C)

FIG. 9A-9F are plan schematic views of a garment rack, robot, and printer according to the invention showing the garment rack bringing a load of garments to the robot (FIG. 9A); the robot carrying a garment it has retrieved from the garment rack and pivoting to the printer (FIG. 9B); the robot loading a garment into the printer for printing (FIG. 9C); the robot withdrawing a garment from the printer after printing (FIG. 9D); the robot carrying a garment it has retrieved from the printer and pivoting to the garment rack (FIG. 9E); and the robot placing the printed garment on the garment rack (FIG. 9F);

FIG. 10 is a side elevation schematic view of a series of garment racks loaded with printed garments passing through a dryer along a guide track according to the invention;

FIG. 11 is a plan schematic view of a series of garment racks loaded with printed garments passing through a cluster of dryers according to the invention; and

FIG. 12 is a plan schematic view of a series of garment racks loaded with printed garments passing through a dryer carousel according to the invention.

### DETAILED DESCRIPTION

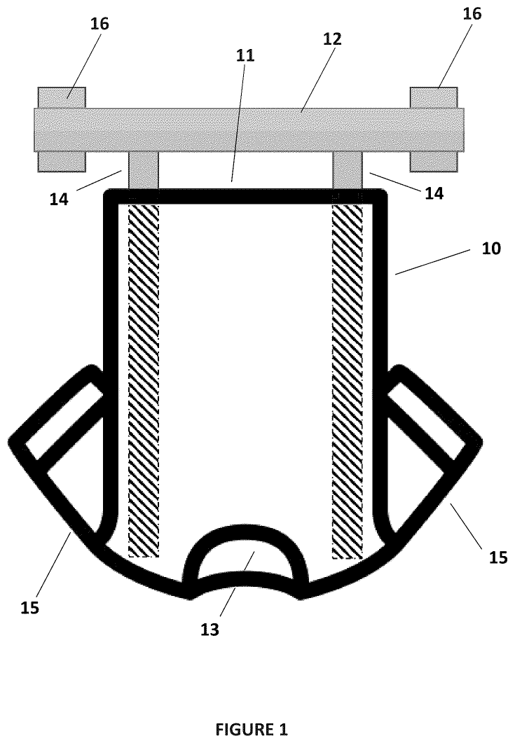

FIG. 1 is a plan schematic view of a garment rack showing a garment in place on the rack according to the invention. In FIG. 1, a rack 12 includes two or more spaced, parallel, horizontal arms that project outwardly therefrom and that are adapted to engage with a garment 10, such as a t-shirt. The arms 14 enter the t-shirt at the waist 11 thereof and extend through the t-shirt to the neck 13 and sleeves 15, in such a way as to lightly stretch the garment to keep it from sagging. Furthermore, the arms 14 are designed to keep the waist side slightly open to facilitate entry of the grabbing hook of the robot. In embodiments of the invention, the rack is mobile and moves from station to station on wheels 16. The arms 14 may be adjustable in width and length to accommodate garments of different sizes.

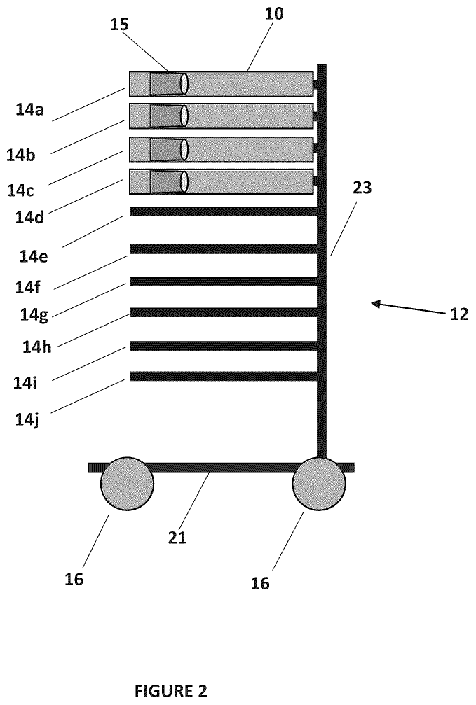

FIG. 2 is a side elevation schematic view of a garment rack according to the invention. In FIG. 2, the rack 12 includes a plurality of spaced parallel arms 14a-14j arranged in tier pairs that project from a frame 23 of the rack. Each tier pair comprises two spaced parallel arms that are adapted to engage with and support a t-shirt 10 from a waist portion thereof outwardly to a sleeve portion 15 thereof.

The rack includes a base portion 21 that supports the frame. In embodiments of the invention the base includes wheels 16 which, in embodiments, are self-propelled for facilitate movement of the rack from station to station in the DTG printing workflow.

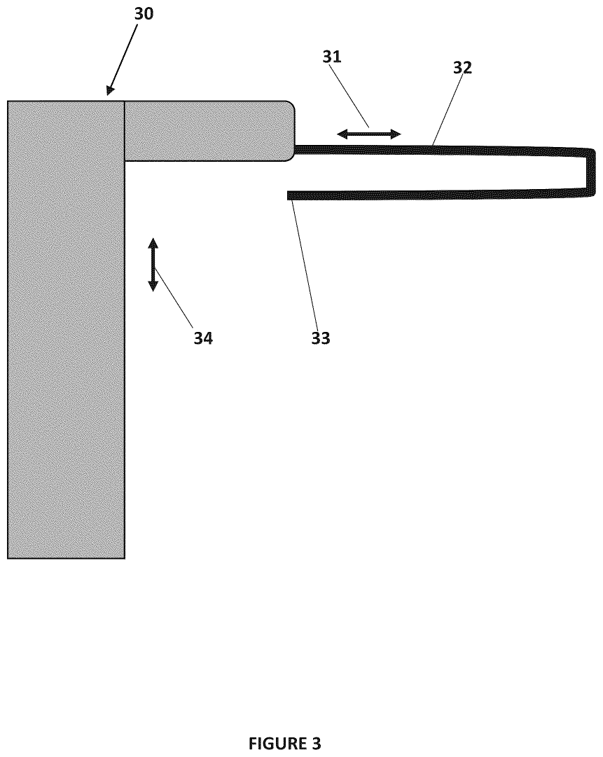

FIG. 3 is a side elevation schematic view of a robot having a pair of direct to garment ibex's-horn-shaped arms mounted thereto to move garments from a garment rack 12 to a printer according to the invention. The shape of the arms allows two arms to be inserted within a t-shirt from the waist portion thereof to hook the t-shirt such that it can be removed from the rack 12 and to support the t-shirt without disturbing the print surface of the t-shirt in such a way as to lightly stretch the garment to keep it from sagging. Furthermore, the arms 32 keep the waist side slightly open to facilitate the placement of the garment onto a garment rack 12 or printer, respectively. In FIG. 3, a robot 30 includes a pair of folded arms 32 having a loop shape that terminates in an opening 33. In embodiments of the invention, the arm can extend horizontally along axis 31 to allow the robot to remove and place the t-shirt on a garment rack 12 or printer, respectively. The arm is also adjustable elevationally up and down along axis 34 to grab a t-shirt and also to remove and replace t-shirts at each of a plurality of garment rack tiers 14.

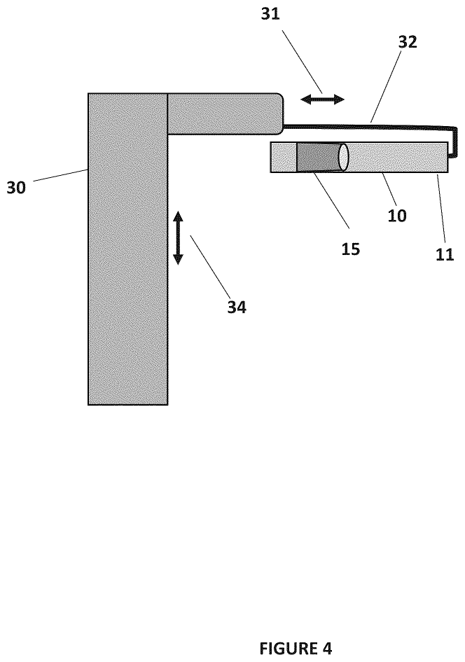

FIG. 4 is a side elevation schematic view of the of FIG. 3 robot after moving the garment from the garment rack for transfer to the printer according to the invention. In FIG. 4, a t-shirt 10 is shown engaged with the robot arm 32. In operation, the arm is extended over the rack with an open end thereof extending beyond the waist portion of the t-shirt. The arms are lowered sufficiently such that the open end of the arm is below a first side the t-shirt and above a second side of the t-shirt such that the open end of the arm enters into the t-shirt between the first and second sides thereof and engages with the t-shirt at the waist portion 11 thereof. The widest opening of the t-shirt is at the waist. In this way it is easy for the arm to pass over the t-shirt and enter the interior of the t-shirt at the waist. Once so engaged, the t-shirt rests on the arm and the arm may be withdrawn from the rack and carry the t-shirt to a printer or other processing location in the DTG printing workflow.

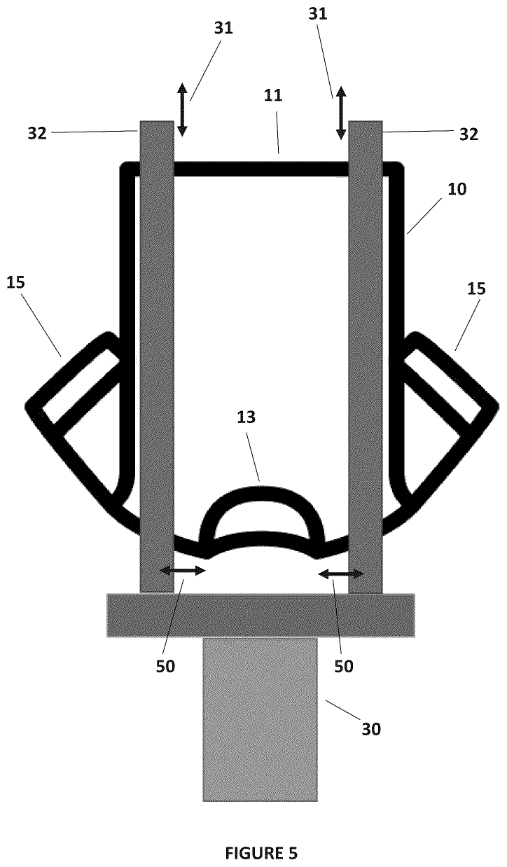

FIG. 5 is a plan schematic view of a robot after moving the garment from the garment rack for transfer to the printer according to the invention. In FIG. 5, the robot 30 has captured a t-shirt 10 from the rack as described above in connection with FIG. 4. The arms 32 can be extended 31 away from and drawn towards the robot as discussed above. The arms are also operable to move horizontally side to side 50 away from and back towards a center portion of the robot. Once the arms have engaged with the t-shirt such side to side movement of the arms alternately stretches the t-shirt to tension the t-shirt to grasp the t-shirt and hold it firmly during transport from and back to the garment rack and to loosen the tension of the arms on t-shirt to allow the t-shirt to be readily engaged with or disengaged from the arms.

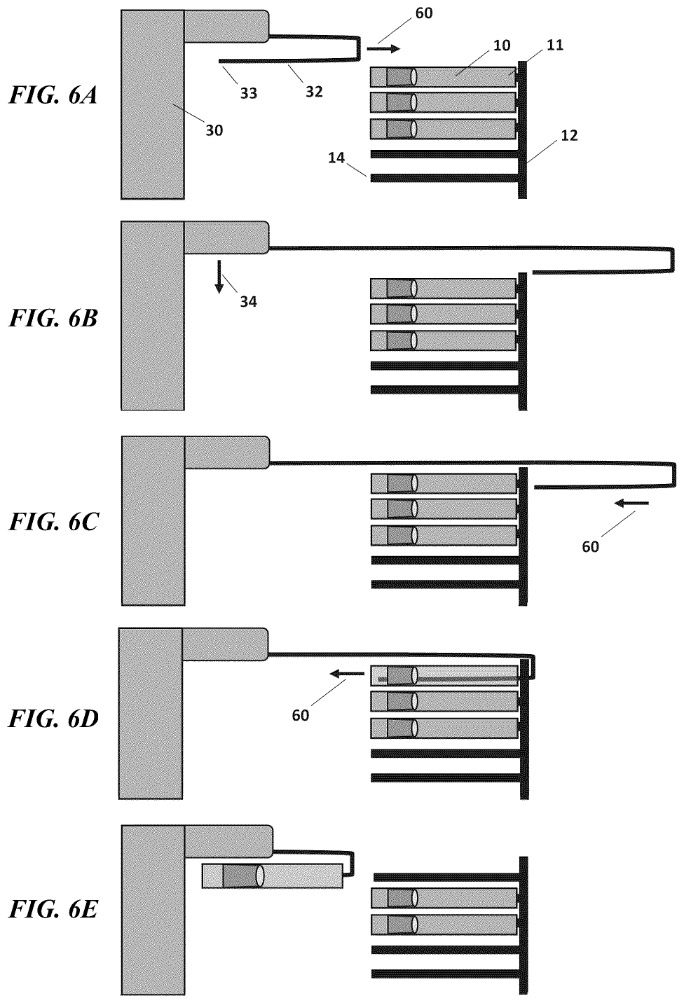

FIGS. 6A-6E are plan schematic views of a robot picking up the garment from the garment rack for transfer to the printer according to the invention. In FIG. 6A, the robot 30 extends its arms 32 toward 60 the rack 12 to engage with a t-shirt 10 that is supported on the rack arms 14. In FIG. 6B the robot 30 reaches behind the rack 12 and descends 34 to position the open end 33 of the arms 32 at the waist side 11 of the T-shirt 10. In FIG. 6C the robot 30 inserts 60 the arms 32 inside the T-shirt 10 and opens the arms to stretch out said T-shirt and grab it from inside the shoulders. In FIG. 6D the robot 30 removes the T-shirt 10 from the rack 12 by retracting 60 the arms 32 and in FIG. 6E the robot is ready to move the garment to the next station in the printing process, e.g. a printer, a drier, a pre-treatment station, storage, packaging, etc.

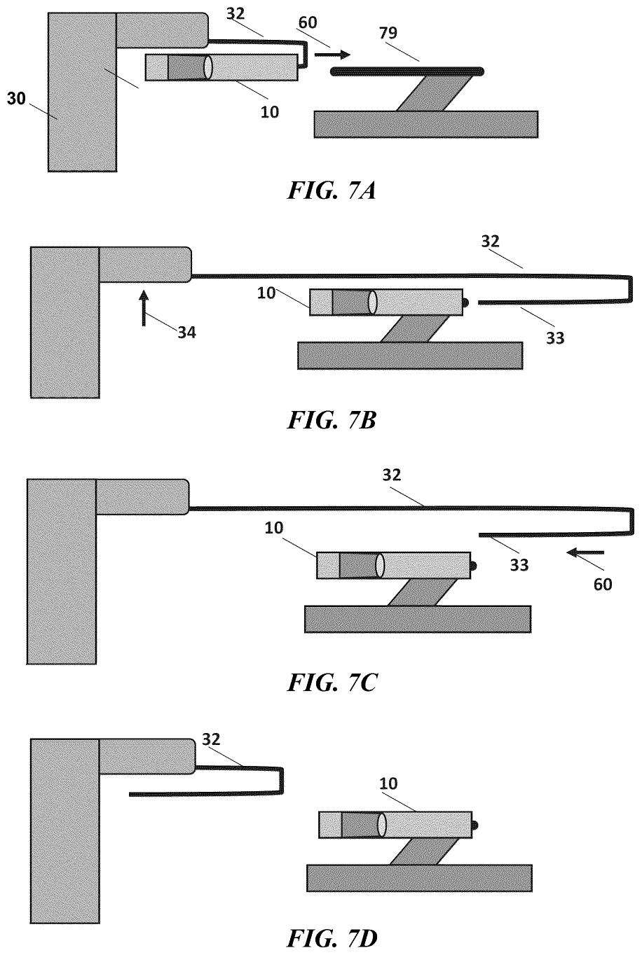

FIGS. 7A-7D are side elevation schematic views of a robot 30 and printer pallet 79, i.e. the printing support usually used in DTG printers (both traditional and digital printers) to lay the garment flat before pre-treatment and printing. In FIG. 7A the robot extends its arms along axis 60 toward the pallet, sliding the T-shirt 10 onto said pallet and opening the arms along axis 50 (see FIG. 5) to straighten and flatten the T-shirt on the pallet. In FIG. 7B the arms of the robot have extended all the way beyond the pallet and are now free of the T-shirt or garment. The robot can rise along axis 34 to disengage the printer pallet. In FIG. 7C the robot retracts its arms along axis 60 and in FIG. 7D the robot is ready for its next operation and the garment is ready to be printed.

The procedures of FIG. 6 and FIG. 7 describe loading and unloading a garment from any station in the printing workflow, be it a garment rack of FIG. 2, a printer pallet of FIG. 7, a drier, a pre-treatment station, storage, a folding station, a packaging station, etc.

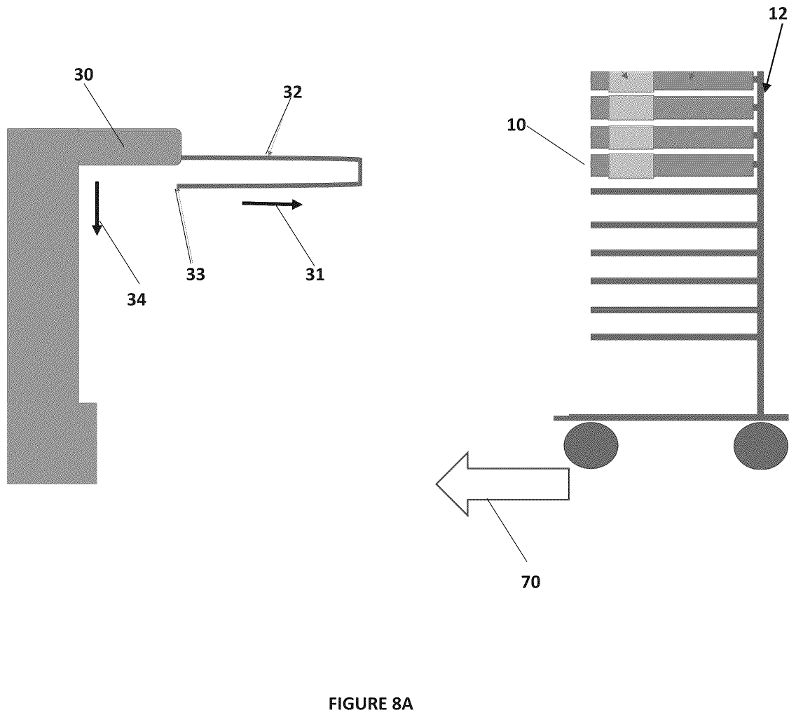

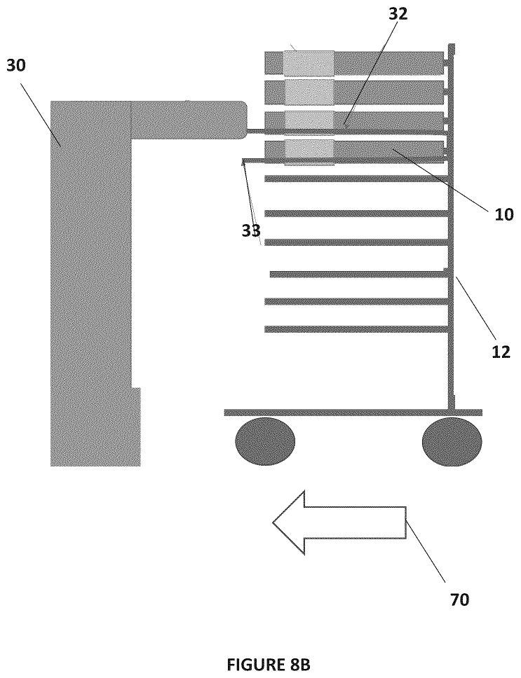

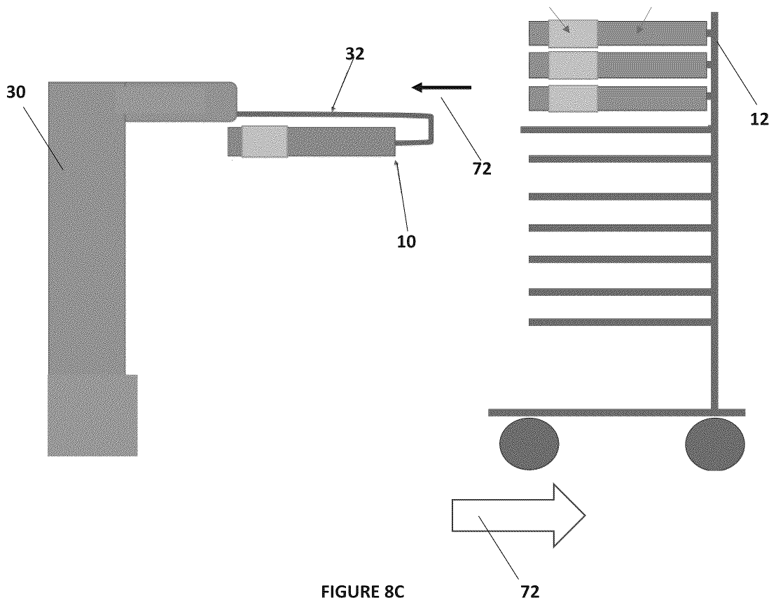

FIGS. 8A-8C are side elevation schematic views of a garment rack and robot according to the invention showing the garment rack bringing a load of garments to the robot (FIG. 8A); the garment rack engaged with the robot where the robot picks up a garment from the garment rack for printing (FIG. 8B); and the garment rack withdrawing from the robot after the robot has picked up a garment for printing (FIG. 8C).

In FIG. 8A, the rack 12 is moving a load of t-shirts 10 toward 70 the robot 30. In this embodiment of the invention the robot is stationary and the rack shuttles the t-shirts from station to station in the DTG workflow.

The robot extends the arm 32 outwardly 31 to grab the t-shirt from the rack. The robot also lowers 34 the arms in this example to allow the robot to grab the t-shirt in the fourth tier of the garment rack from the top. The robot is adapted to position the arms to individually grab any of the several t-shirts that are carried by the rack. As shown in FIG. 8A, the t-shirts are stacked on their respective rack arms, one above the other. The up and down adjustment of the robot arms allows each of the t-shirts to be grabbed from the rack for processing and returned to the rack at the same location on the rack after processing.

While the embodiment of FIG. 8A shows the garment rack moving toward the stationary robot, in other embodiments of the invention, the garment rack can be stationary and the robot mobile, or both the robot and the garment rack may be mobile.

In FIG. 8B, the robot 30 is shown engaged with the garment rack 12. The robot arms 32 have been extended over and past the t-shirt such that the open ends of the arms are drawn into the t-shirt from the waist portion thereof. As noted above, the arms have a curved or loop shape similar to the of an ibex horn. Other embodiments of the invention may apply variations of this shape but, significantly, the recurve of the robot arm allows the t-shirt to be snagged and drawn from the garment rack without changing the shape of the t-shirt. This is important for printing because the t-shirt must present a consistent flat surface to the printer for printing. Because the robot arms gently grab and support the t-shirt during movement from the garment rack to a printer the t-shirt is maintained in the same flat, lightly stretched configuration as when it was first placed on the garment rack to avoid sagging, and with the waist side ajar, to allow entrance and exit of robot arms, rack arms, printer pallet, etc.

In FIG. 8C, the t-shirt 10 is carried by the robot 30 as the garment rack withdraws 72 therefrom. The t-shirt may now be presented by the robot to a printer or other processing station in the DTG printing workflow.

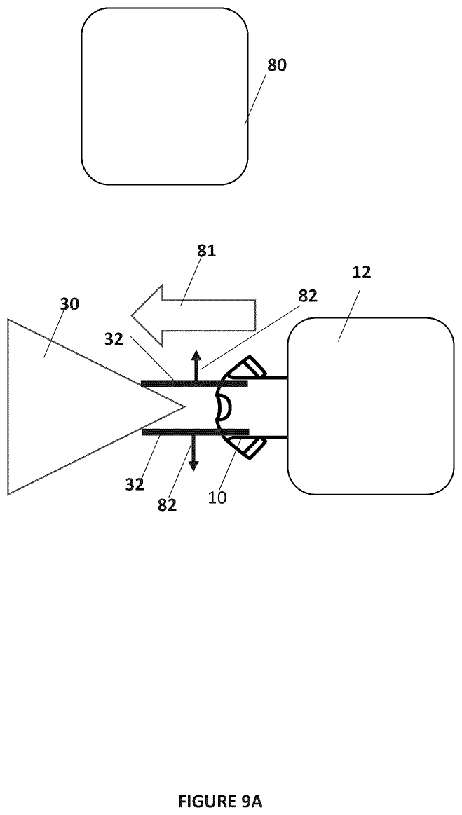

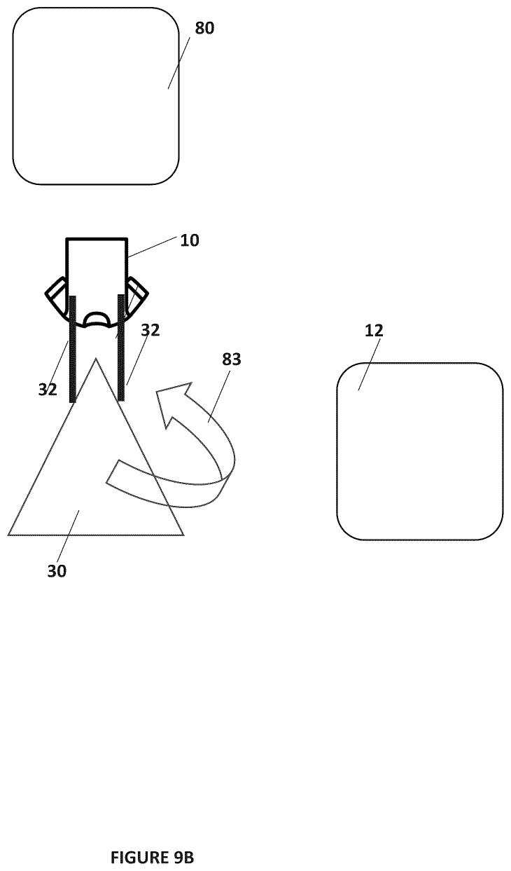

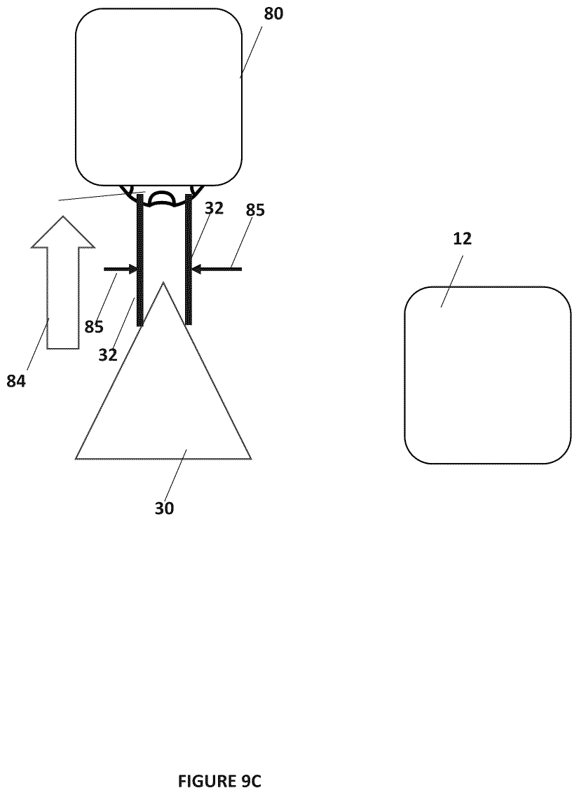

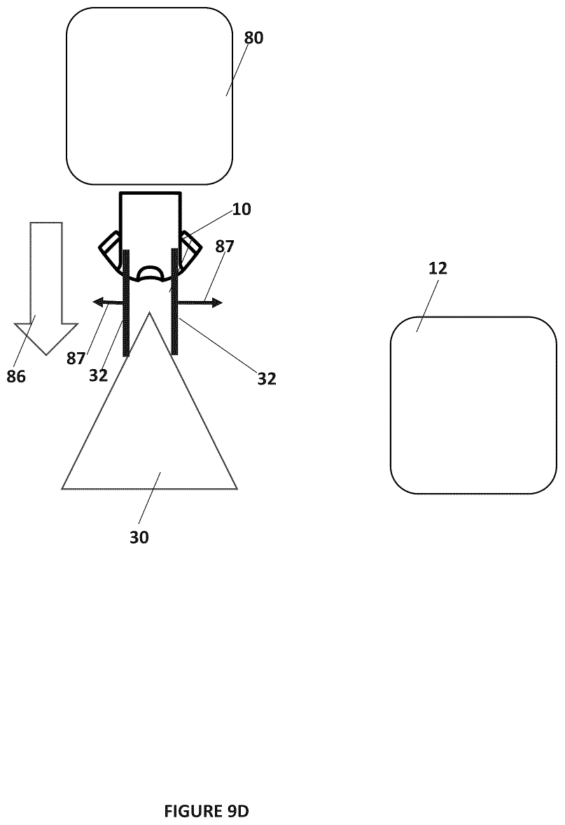

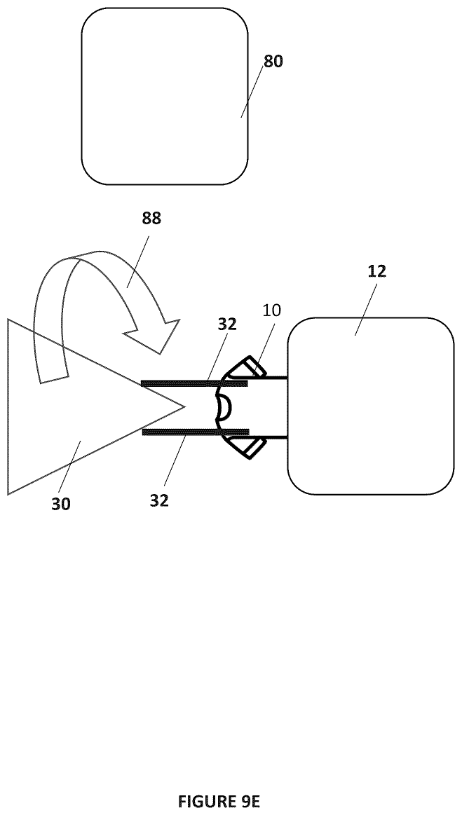

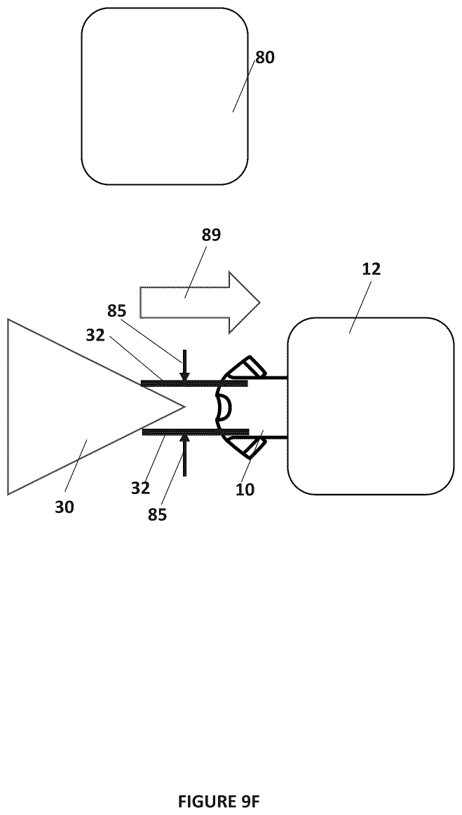

FIG. 9A-9F are plan schematic views of a garment rack, robot, and printer according to the invention showing the garment rack bringing a load of garments to the robot (FIG. 9A); the robot carrying a garment it has retrieved from the garment rack and pivoting to the printer (FIG. 9B); the robot loading a garment into the printer for printing (FIG. 9C); the robot withdrawing a garment from the printer after printing (FIG. 9D); the robot carrying a garment it has retrieved from the printer and pivoting to the garment rack (FIG. 9E); and the robot placing the printed garment on the garment rack (FIG. 9F).

In FIG. 9A, the garment rack 12 is moved toward 81 the robot 30, the robot arms 32 engage with the t-shirt 10 and then extend outwardly 82 to tension the t-shirt to hold it securely to the robot arms during movement away from the garment rack.

In FIG. 9B, the robot is a stationary machine that pivots 83 toward the printer 80. In other embodiments of the invention, the robot may be a mobile machine that carries the t-shirt to the printer. The system can work with both traditional and digital DTG printers. In embodiments, a standard printer would need some modifications, but only to the pallet that receives and holds the T-shirt inside the printer. Pallets have been designed for a human to load garments and should be optimized to interact with the robot of the invention. However, pallets would need only shape modifications to allow the arms of the robot to load and unload the garment without interference with the printer. No additional movement of the pallets is required.

In FIG. 9C, the robot extends its arms 32 outwardly 84 toward the printer to place the t-shirt 10 into a printing position within the printer 80. The robot then moves the arms inwardly 85 toward a center to release tension on the t-shirt such that the robot may withdraw its arms from the t-shirt during printing. In other embodiments of the invention, the t-shirt is held in the printer by the robot arms during printing rather than being disengaged from the robot arms during printing. In such embodiments, the robot arms may pivot axially away from vertical so that they are coplanar with the printing surface of the t-shirt. In this way, the robot arms do not interfere with or impede movement of the printer mechanism and print head as it prints on the t-shirts.

In FIG. 9D, the robot has grabbed the t-shirt and spreads its arms 87 to tension the t-shirt as it withdraws it 86 from the printer.

In FIG. 9E, the robot pivots 88 toward the garment rack 12 in preparation for replacing the now printed t-shirt on the garment rack.

In FIG. 9F, the robot arms are moved toward 89 the garment rack, the t-shirt is placed in the garment rack arms, and the robot arms are moved toward a center 85 to release tension on the t-shirt such that the robot arms may be withdrawn from the garment rack while leaving the t-shirt in place in the garment rack.

The process of FIG. 9A-9F is repeated until all of the t-shirts on the rack have been printed.

State of the art DTG facilities use dryers that are very similar to the textile industry, i.e. they have a belt running through the dryer. The t-shirts are laid down on the belt by a human operator one at a time, they cross through the dryer, and they get to the other side of the dryer where there is another human operator taking the t-shirts off.

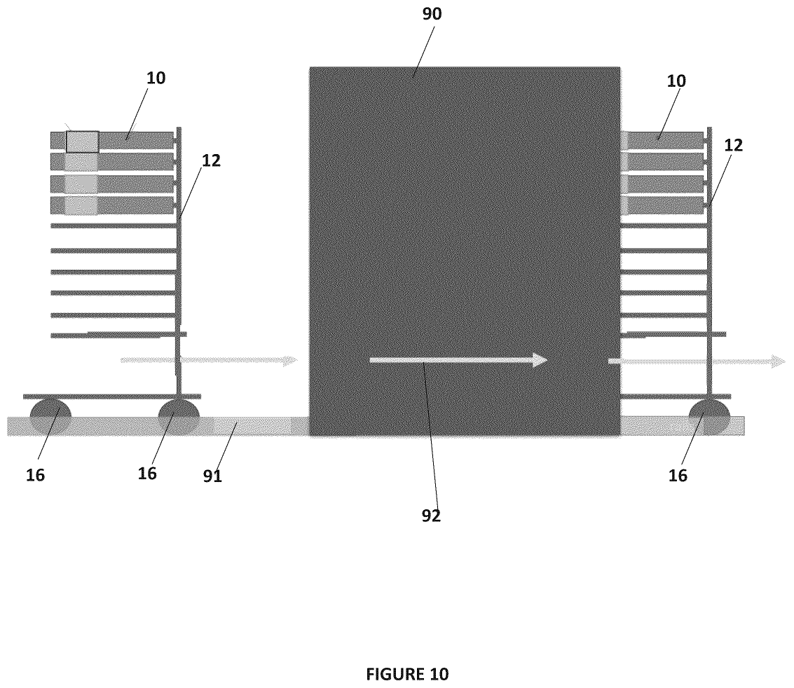

FIG. 10 is a side elevation schematic view of a series of garment racks loaded with printed garments passing through a dryer along a guide track according to the invention. In FIG. 10, an embodiment of the invention provides a dryer 90 in which several garment racks 12 carrying loads of printed t-shirts 10 are moved sequentially through the dryer 92 along a track 91 via wheels 16 at the base of the garment rack. The t-shirts pass through the dryer at a rate that is sufficient to dry the printed t-shirts thoroughly.

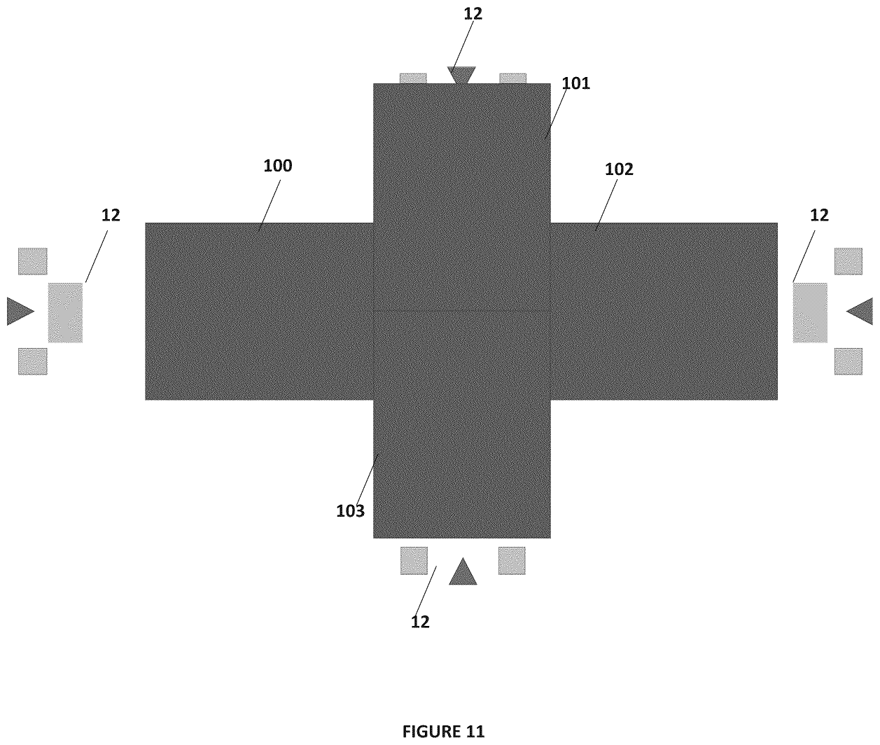

FIG. 11 is a plan schematic view of a series of garment racks loaded with printed garments passing through a cluster of dryers according to the invention. In FIG. 11, a cluster of dryers 100-103 is provided each of which is accessible by one of several garment racks 12. In this embodiment of the invention, each rack is loaded with printed t-shirts and moved by the rack into a respective dryer. The rack remains in the dryer until sufficient time has passed to dry the t-shirts, after which the garment rack withdraws from the dryer and shuttles the now dry, printed t-shirts to a next location in the DTG printing workflow. The garment rack and/or the dryer may include various sensors that determine when the t-shirts are dry. While a cluster of four dryers is shown in FIG. 10, those skilled in the art will appreciate the any number of dryers can be arranged in a cluster as desired.

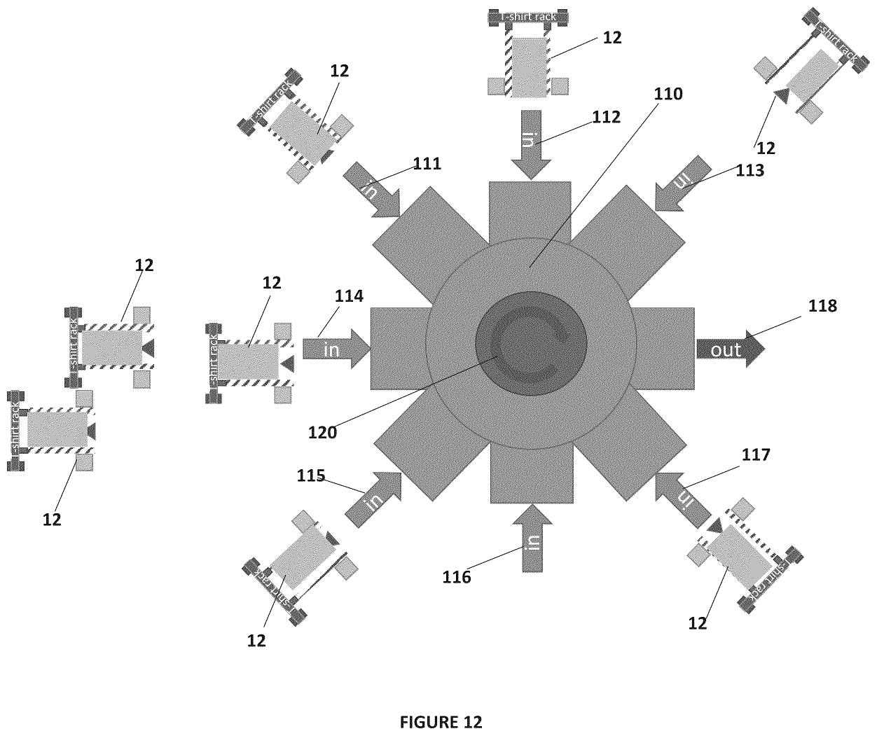

FIG. 12 is a plan schematic view of a series of garment racks loaded with printed garments passing through a dryer carousel according to the invention. In FIG. 12, a dryer 110 includes an internal carousel 120. The dryer has a plurality of inlet ports 111-117 through which garment racks 12 which carry a load of printer t-shirts may enter the dryer. Once inside the dryer, the garment racks are moved through the dryer by the carousel until such time as the printed t-shirts are dry, at which point the garment racks exit 118 the dryer.

One feature of the invention is the use of garment racks that may be moved along a DTG printing workflow by use of telemetry or other guidance, e.g. similar to those mechanisms used in automated warehouses such as those operated by Amazon.com. For example, once the t-shirts are printed and dried, they are ready to be folded. The garment rack carrying the printed and dried t-shirts rack could then go to a folding machine that folds and packages the t-shirts or it could be routed to a folding locations where a human being takes the t-shirts off the rack and folds them.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

I/We claim:

1. Apparatus for facilitating direct to garment (DTG) printing, comprising:
a garment rack comprising a plurality of tiers of parallel arms, each said tier adapted to receive, support, and shuttle a garment between one or more stations within a DTG printing workflow.

2. The apparatus of claim 1, wherein said rack is further adapted to transport said plurality of garments to a robot which manages processing of the garments at at least one of said stations within said DTG printing workflow.

3. The apparatus of claim 1, wherein said garments comprise t-shirts.

4. The apparatus of claim 2, wherein at least one of said stations within said DTG printing workflow comprises a printer, and wherein said rack presents said plurality of garments to said robot for transfer of one of said garments at a time from the rack into said printer for printing thereon.

5. The apparatus of claim 4, wherein the rack receives a printed garment from the robot after said robot removes the printed garment from the printer.

6. The apparatus of claim 4, wherein said robot comprises a robotic system that comprises a pair of parallel arms, each arm having a curved member similar in shape to an ibex horn.

7. The apparatus of claim 1, wherein at least one of said stations within said DTG printing workflow comprises a dryer and wherein said rack carries printed garments to, into, or through said dryer to effect drying of the printed garments.

8. The apparatus of claim 1, wherein said rack is self-propelled.

9. Apparatus for facilitating direct to garment (DTG) printing, comprising:
a robot having a pair of parallel folded arms, each arm having a loop shape that terminates in an opening at a lower portion of the loop, mounted thereto and adapted to move a garment from a garment rack to a printer, wherein the arms are adapted for parallel outward horizontal movement from the robot above a print surface of the garment with the opening of the arms extending beyond an open portion of the garment, wherein the arms are lowered to allow insertion of the arms within the garment from the open portion thereof to hook the garment, wherein the arms are then drawn inwardly to the robot to remove the garment from the rack, and support the garment without deforming a garment print surface during transfer between the printer and the garment rack.

10. The apparatus of claim 9, wherein said pair of arms is adjustable horizontally to and from said robot in tandem to transfer said garment between the garment rack and the printer, respectively.

11. The apparatus of claim 9, further comprising:
a garment rack comprising a plurality of vertically spaced tier pairs, wherein each tier pair comprises two spaced, horizontal, parallel arms that are adapted to engage with and support a garment.

12. The apparatus of claim 11, wherein said pair of arms is adjustable elevationally up and down to remove and replace garments on each of said plurality of vertically spaced garment rack tiers.

13. The apparatus of claim 11, wherein said garment the rack is self-propelled to facilitate movement of the rack from station to station within a DTG printing workflow.

14. A direct to garment (DTG) printing method, comprising:
providing a robot having a pair of parallel folded arms, each arm having a loop shape that terminates in an opening at a lower bout of the loop, mounted thereto and adapted to move a garment from a garment rack to a printer, wherein the arms are adapted for insertion within a garment from an open portion thereof to hook the garment, remove the garment from the rack, and support the garment without deforming a garment print surface during transfer between the printer and the garment rack, the robot performing the steps of:
extending the parallel arms over the garment rack past an opening to an interior of the garment, lowering the arms to position the opening thereof between a garment opening defined by an upper and a lower portion of the garment, and engaging the opening of the arm with an open end of garment by passing the parallel arms over the garment and entering an interior of the garment at the open end thereof; and
withdrawing the parallel arms from the garment rack while supporting the garment to transfer the garment to one or more other processing locations in a DTG printing workflow.

15. The method of claim 14, further comprising:
after the parallel arms have been engaged with the garment, moving the parallel arms apart horizontally side to side to tension the garment and hold the garment firmly during transport between the garment rack and one or more other processing locations in the DTG printing workflow.

16. The method of claim 15, further comprising:
moving the parallel arms together horizontally side to side to release tension on the garment after transport between the garment rack and one or more other processing locations in the DTG printing workflow.

17. The method of claim 14, wherein the garment rack comprises a plurality of vertically spaced tier pairs, wherein each tier pair comprises two spaced, horizontal, parallel arms that are adapted to engage with and support a garment;
said method further comprising:
moving the parallel arms elevationally up and down to remove and replace garments individually on each of said plurality of vertically spaced garment rack tiers.

18. A direct to garment (DTG) printing method, comprising:
a self-propelled garment rack moving a plurality of garments to be printed to a robot;
said robot extending a pair of parallel spaced folded arms for engagement with a garment on said garment rack, each arm having a loop shape that terminates in an opening that enters an open portion of said garment to engage with and carry said garment.

19. The direct to garment (DTG) printing method of claim 18, further comprising:
spreading said pair of parallel spaced folded arms apart horizontally to tension the garment to hold the garment securely to the parallel spaced folded arms during transfer of the garment from the garment rack.

20. The direct to garment (DTG) printing method of claim 19, further comprising:
pivoting said robot toward a processing location in a DTG printing workflow to position said garment at said processing location.

21. The direct to garment (DTG) printing method of claim 20, further comprising:
extending said pair of parallel spaced folded arms at said robot toward the processing location in the DTG printing workflow to transfer the garment to the processing location in the DTG printing workflow.

22. The direct to garment (DTG) printing method of claim 21, further comprising:
moving said pair of parallel spaced folded arms together horizontally to release tension on the garment to withdraw the pair of parallel spaced folded arms from the garment during processing at the processing location in the DTG printing workflow.

23. The direct to garment (DTG) printing method of claim 22, further comprising:
after garment processing at the processing location in the DTG printing workflow, extending the pair of parallel spaced folded arms at said robot for engagement with a garment at the processing location in the DTG printing workflow.

24. The direct to garment (DTG) printing method of claim 23, further comprising:
spreading said pair of parallel spaced folded arms apart horizontally to tension the garment to hold the garment securely to the parallel spaced folded arms during transfer of the garment from the processing location in the DTG printing workflow;
pivoting said robot toward said garment rack;
extending said pair of parallel spaced folded arms at said robot toward the garment rack to transfer the garment to the garment rack; and
moving said pair of parallel spaced folded arms together horizontally to release tension on the garment to withdraw the pair of parallel spaced folded arms from the garment, wherein said garment is returned to said garment rack.

25. The direct to garment (DTG) printing method of claim 24, further comprising:
repeating the steps of said method until each of the plurality of t-shirts on the garment rack have been transferred from the garment rack to the processing location in the DTG printing workflow, processed at the processing location in the DTG printing workflow, and returned to the garment rack.

26. Method for facilitating direct to garment (DTG) printing, comprising:
providing a plurality of self-propelled garment racks, each of said garment racks comprising a plurality of tiers of parallel arms, each said tier adapted to receive, support, and shuttle a garment, each said garment rack sequentially transporting said garments thereon along a guide track and through a dryer.

27. Method for facilitating direct to garment (DTG) printing, comprising:
providing a plurality of self-propelled garment racks, each of said garment racks comprising a plurality of tiers of parallel arms, each said tier adapted to receive, support, and shuttle a garment, each said garment rack transporting said garments thereon to an available dryer within a cluster of dryers, wherein said rack enters said dryer and remains within the dryer until sufficient time has passed to dry the garments thereon, after which the garment rack withdraws from the dryer and shuttles the now dry garments to a next location in a DTG printing workflow.

28. Method for facilitating direct to garment (DTG) printing, comprising:
providing a plurality of self-propelled garment racks, each of said garment racks comprising a plurality of tiers of parallel arms, each said tier adapted to receive, support, and shuttle a garment, each said garment rack transporting said garments thereon to a dryer comprising an internal carousel, wherein said dryer comprises a plurality of inlet ports through which garment racks 12 which carry a load of garments into the dryer, wherein once inside the dryer, the garment racks are moved through the dryer by the carousel until such time as the garments are dry, at which point the garment racks exit the dryer at one of one or more exit ports.
